(19) United States
(12) Patent Application Publication
(10) Pub. No.: US 2023/0063132 A1
(43) Pub. Date: Mar. 2, 2023

(54) System for augmenting the velocity of a motorized vehicle

(71) Applicant: Luis Vazquez, San Juan, PR (US)

(72) Inventor: Luis Vazquez, San Juan, PR (US)

(21) Appl. No.: 17/892,329

(22) Filed: Aug. 22, 2022

Related U.S. Application Data
(60) Provisional application No. 63/236,519, filed on Aug. 24, 2021.

(51) Int. Cl. F16H 57/021; F16H 1/20; B60K 17/08

(52) U.S. Cl. CPC F16H 57/021; F16H 1/20; B60K 17/08; F16H 2057/0216; F16H 2057/02043

(57) ABSTRACT

A system for augmenting the velocity of a motorized vehicle that includes a series of sprockets that interact with each other increasing the torque generated from the transmission of the vehicle and delivered through the drive shaft, thereby increasing the velocity of the vehicle.

### STATEMENT REGARDING FEDERALLY SPONSORED RESEARCH AND DEVELOPMENT

N/A

### RELATED APPLICATIONS

N/A

### BACKGROUND OF THE INVENTION

### 1. Technical Field

The present invention relates generally to a system for increasing or augmenting the velocity of a motorized vehicle.

### 2. Background Information

There are a variety of ways of adding extra power to a motor vehicle. Popular methods to make a vehicle go faster include 1) upgrading the vehicle's intake to allow the engine is to breathe easier; 2) performance exhaust modification; 3) adding software that adjust the ignition timing to smooth out power delivery; 4) forced induction in the form of a turbocharger or a supercharger; 5) rebuilding the engine with performance parts; or 6) simply swapping a current engine for a more powerful one. These methods, however, are either overly expensive or do not increase the velocity of the vehicle significantly; and if it does, it only increases power or velocity temporarily. The present disclosure, on the other hand, relates to a structure that significantly increases the velocity of a motor vehicle in a permanent manner.

### SUMMARY OF THE INVENTION

A system for augmenting the velocity of a motorized vehicle comprising a series of sprockets that interact with each other increasing the torque generated from the transmission of the vehicle and delivered through the drive shaft, thereby increasing the velocity of the vehicle.

Particularly, the subject disclosure relates to a system for increasing the velocity of a motorized vehicle, comprising: a housing, a plurality of bases, a plurality of sprockets, a plurality of ball bearings, an axle, and a drive shaft; wherein the housing includes a bottom, a first outer wall, a second outer wall, and an inner wall, and wherein the first outer wall, the second outer wall, and the inner wall are all perpendicularly connected to the bottom of the housing; wherein the inner wall divides the housing into two sections or compartments; wherein the first compartment comprises a first base configured to support is a first ball bearing, a second base located opposite to the first base and configured to support a second ball bearing, and a first sprocket located between the first and second ball bearings, wherein the first sprocket is connected to at least one of the first or second ball bearings; wherein the first compartment further comprises a third base configured to support a third ball bearing, a fourth base located opposite to the third base and configured to support a fourth ball bearing, and a second sprocket located between the third and fourth ball bearings, wherein the second sprocket is connected to at least one of the third or fourth ball bearings; wherein both the first sprocket and the second sprocket comprise teeth that are in contact with each other and are configured to interact with each other; wherein the first base and the third base of the first compartment are located on the first outer wall and secured thereto via one or more screws, and wherein the second base and the fourth base of the first compartment are located on the inner wall and secured thereto via one or more screws; wherein the second compartment comprises a first base configured to support a first ball bearing, a second base located opposite to the firsts base and configured to support a second ball bearing, and a third sprocket located between the first and second ball bearings, wherein the third sprocket is connected to at least one of the first or second ball bearings; wherein the second compartment further comprises a third base configured to support a third ball bearing, a fourth base located opposite to the third base and configured to support a fourth ball bearing, and a fourth sprocket located between the third and fourth ball bearings, wherein the fourth sprocket is connected to at least one of the third or fourth ball bearings; wherein both the third sprocket and the fourth sprocket comprise teeth that are in contact with each other and are configured to interact with each other; wherein the first base and the third base of the second compartment are is located on the inner wall and secured thereto via one or more screws, and wherein the second base and the fourth base of the second compartment are located on the second outer wall and secured thereto via one or more screws; wherein each base comprises one or more inserts configured to receive the corresponding one or more screws for securing each base to the corresponding inner wall or outer wall; wherein each of the inner wall and the outer wall includes one or more holes corresponding with the inserts of each base; wherein each of the first base and the second base of the first compartment include an opening configured to receive a first portion of the drive shaft; wherein each of the third base and the fourth base of the first compartment include an opening configured to receive an axle; wherein each of the first base and the second base of the second compartment include an opening configured to receive the axle; wherein each of the third base and the fourth base of the second compartment include an opening configured to receive a second portion of the drive shaft; wherein the first outer wall is configured to receive the first portion of the drive shaft; wherein the second outer wall is configured to receive the second portion of the drive shaft; wherein the inner wall is configured to receive the axle; wherein the axle comprises a first end perpendicularly coupled to the second sprocket and a second end coupled to the third sprocket; wherein a first portion of the drive shaft is perpendicularly coupled to the first sprocket; and wherein a second portion of the drive shaft is perpendicularly coupled to the fourth sprocket.

The present disclosure may address one or more of the problems and deficiencies of the prior art discussed above. However, it is contemplated that the disclosure may prove useful in addressing other problems and deficiencies in a number of technical areas. Therefore, the claimed invention should not necessarily be construed as limited to addressing any of the particular problems or deficiencies discussed herein.

### BRIEF DESCRIPTION OF THE DRAWINGS

The present invention is described with reference to the accompanying drawings. In the drawings, like reference numbers indicate identical or functionally similar elements.

FIG. 1 shows a front view of the components of a system for augmenting the velocity of a motorized vehicle, in accordance with principles of the present disclosure.

FIG. 2 shows a rear view of the components of the system for augmenting the velocity of a motorized vehicle, in accordance with principles of the present disclosure.

FIG. 3 shows a top view of the components of the system for augmenting the velocity of a motorized vehicle, in accordance with principles of the present disclosure.

FIG. 4 shows a side view of the components of the system for augmenting the velocity of a motorized vehicle, in accordance with principles of the present disclosure.

FIG. 5 shows the system for augmenting the velocity of a motorized vehicle installed in a rear-wheel drive vehicle, in accordance with principles of the present disclosure.

FIG. 6 shows the system for augmenting the velocity of a motorized vehicle installed in a four-wheel drive vehicle, in accordance with principles of the present disclosure.

### DETAILED DESCRIPTION OF THE INVENTION

In the Summary above, the Description below, and in the accompanying drawings, reference is made to particular features of the present disclosure. It is to be understood that the disclosure includes possible combinations of such particular features. For example, where a particular feature is disclosed in the context of a particular aspect or exemplary embodiment, or a particular claim, that feature can also be used, to the extent possible, in combination with and/or in the context of other particular aspects and exemplary embodiments, and in the invention generally.

The term “comprises”, and grammatical equivalents thereof are used herein to mean that other components, structures, steps, etc. are optionally present. For example, an article “comprising” (or “which comprises”) components A, B, and C can consist of (i.e., contain only) components A, B, and C, or can contain not only components A, B, and C, but also one or more other components or structures.

The term “at least” followed by a number is used herein to denote the start of a range beginning with that number (which may be a range having an upper limit or no upper limit, depending on the variable being defined). For example, “at least 1” means 1 and/or more than 1.

While the specification will conclude defining the features of exemplary embodiments of the disclosure that are regarded as novel, it is believed that the disclosure will be better understood from a consideration of the following description in conjunction with the figures, in which like reference numerals are carried forward.

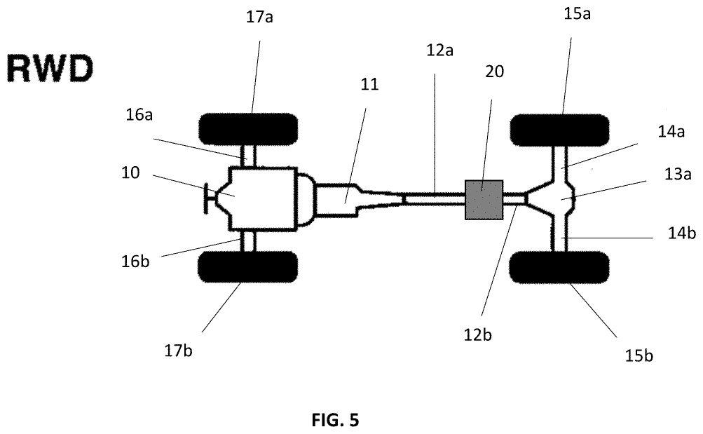

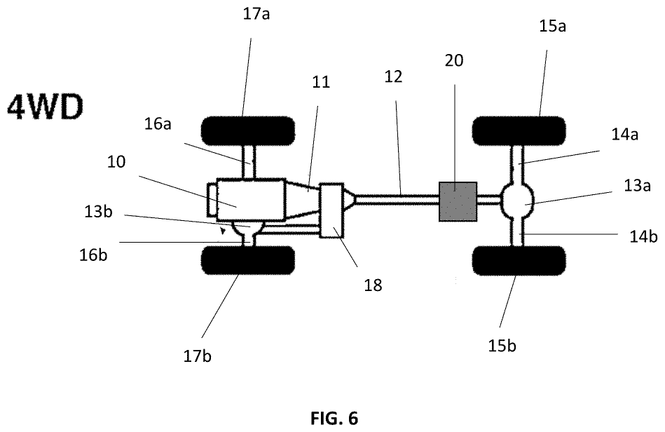

As shown in FIG. 5, a rear-wheel drive vehicles generally comprises an engine or motor 10 that is coupled to a transmission 11. The transmission 11, in turn, is coupled to a drive shaft 12; and the drive shaft 12 is coupled to a rear differential 13a. The rear differential 13a, in turn, is coupled to opposite rear axle shafts 14a, 14b, which are respectively coupled to the vehicle's rear wheels 15a, 15b. The motor engine 10 in turn, is coupled to front axle shafts 16a, 16b, which are respectively coupled to the vehicle's front wheels 17a, 17b. In four-wheel drive vehicles, as shown in FIG. 6, the motor engine 10 is coupled to a front differential 13b, which in turn, is coupled to opposite front axle shafts 16a, 16b that are respectively coupled to the vehicle's front wheels 17a, 17b. The transmission 11, in turn, is coupled to a transfer case 18 that interacts with the front and rear differentials 13a, 13b. The transfer case 18 transfers power from the transmission 11 to the front and rear axle shafts 14a, 14b, and 16a, 16b.

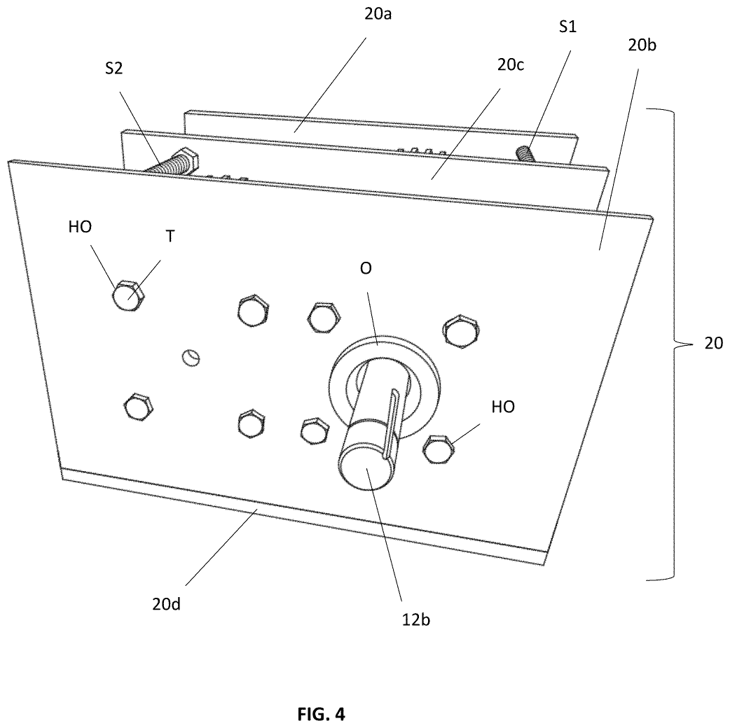

In rear-wheel drive vehicles, the drive shaft 12 delivers torque from the transmission 11 to the rear differential 13a (including the rear axle shafts 14a, 14b), which then transmits this torque to the wheels in order to move the vehicle. The system 1 for increasing or augmenting the velocity of a motorized vehicle takes advantage of this mechanism by providing a structure that increases the rate at which the axle shafts 14a, 14b, and 16a, 16b rotate the wheels of the vehicle, thereby increasing the velocity of the vehicle. As shown in FIG. 4, the system 1 comprises a housing 20 having a bottom 20d, first and second outer walls 20a, 20b and an inner wall 20c, wherein the first and second outer walls 20a, 20b and the inner wall 20c are all perpendicularly connected or welded to the bottom 20d of the housing. The inner wall 20c divides the housing 20 into two sections or compartments 21a, 21b, preferably having the same size. The housing 20 may include one or more screws S1, S2, adapted to adjust or provide support to the outer and inner walls 20a-20c. The system 1 is adapted to be attached to the drive shaft 12 located between the transmission 11 and the rear differential 13a. The housing 20 can be manufactured from any metal alloy commonly used in the automobile industry, such as aluminum, iron, or the like.

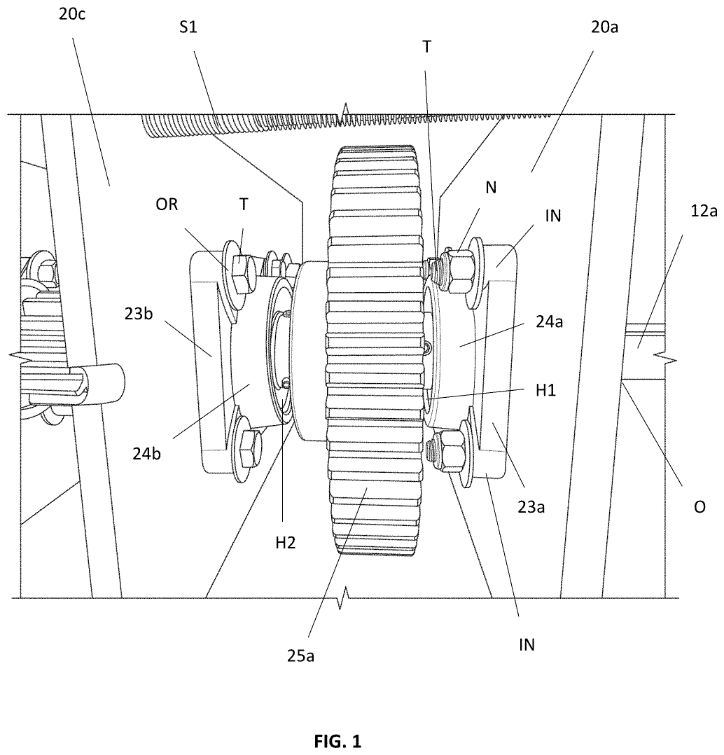

As shown in FIGS. 1-3, the first compartment 21a comprises a first base 23a configured to support a first ball bearing 24a or similar structure; a second base 23b located opposite to the first base 23a and configured to support a second ball bearing 24b; and a first sprocket 25a located between the first and second ball bearings 24a, 24b, wherein the sprocket 25a is connected or coupled to at least one of the first or second ball bearings 24a, 24b. The first compartment 21a further comprises a third base 23c configured to support a third ball bearing 24c; a fourth base 23d located opposite to the third base 23c and configured to support a fourth ball bearing 24d; and a second sprocket 25b between the third and fourth ball bearings 24c, 24d, wherein the second sprocket 25b is connected or coupled to at least one of the third or fourth ball bearings 24c, 24d. It should be noted that the first sprocket 25a is larger in size than the second sprocket 25b; and that both the first sprocket 25a and the second sprocket 25b comprise teeth that are in contact with each other and are configured to interact with each other. As such, when the first sprocket 25a rotates, it causes the second sprocket 25b to also rotate; and vice versa. It should also be noted that the first base 23a and the third base 23c of the first compartment are located on the first outer wall 20a and secured thereto via one or more screws, and that the second base 23b and the fourth base 23d of the first compartment are located on inner wall 20c and secured thereto via one or more screws.

Similarly, the second compartment 21b comprises a first base 23e configured to support a first ball bearing 24e; a second base 23f located opposite to the first base 23e and configured to support a second ball bearing 24f; and a third sprocket 25c located between the first and second ball bearings 24e, 24f, wherein said third sprocket 25c is connected or coupled to at least one of the first or second ball bearings 24e, 24f. The second compartment 21b further comprises a third base 23g configured to support a third ball bearing 24g; a fourth base 23h located opposite to the third base 23g and configured to support a fourth ball bearing 24h; and a fourth sprocket 25d located between the third and fourth ball bearings 24g, 24h, wherein said fourth sprocket 25d is connected or coupled to at least one of the third or fourth ball bearings 24g, 24h. It should be noted that the third sprocket 25c is larger in size than the fourth sprocket 25d; and that both the third sprocket 25c and the fourth sprocket 25d comprise teeth that are in contact with each other and are configured to interact with each other. As such, when the third sprocket 25c rotates, it causes the fourth sprocket 25d to also rotate; and vice versa. It should also be noted that the first base 23e and the third base 23g of the second compartment are located on the inner wall 20c and secured thereto via one or more screws, and that the second base 23f and the fourth base 23h of the second compartment are located on the second outer wall 20b and secured thereto via one or more screws.

Additionally, each base 23a-23h comprises one or more inserts IN (preferably threaded) configured to receive one or more screws T for securing the bases 23a-23h to the corresponding wall 20a-20c. Likewise, each wall 20a-20c includes one or more holes HO corresponding with the inserts IN of each base 23a-23h. Accordingly, each base 23a-23h can be secured thereto (to the walls 20a-20c) when the one or more screws T are inserted via the corresponding hole HO and insert IN. It should be noted that the bases is 23a-23h may be further secured to the corresponding wall by using nuts N and/or O-rings OR in combination with the one or more screws T. For example, if screw T is inserted (from outside of the housing 20) through a hole HO (on the first outer wall 20a) corresponding with an insert IN on base 23a, the portion of the screw T that comes out of the insert IN in base 23a can be further secured via the nut N and O-ring OR, as shown in FIG. 1. A similar approach may be used with base 23c, which is also located on the first outer wall 20a. Moreover, the one or more screws T can be used to secure two bases on the inner wall 20c that are opposite to each other (i.e., bases located on separate compartments 21a, 21b). For example, the second base and the fourth base of the first compartment; and the first base and the third base of the second compartment can be secured to the inner wall via the same set of screws from the one or more screws.

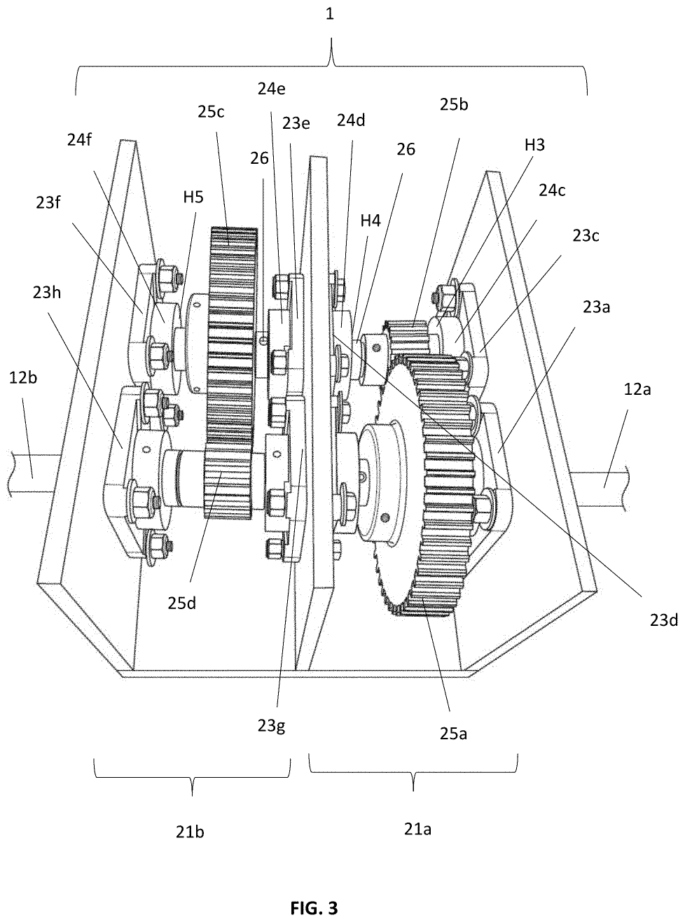

As a further example, if screw T is inserted through a hole HO (on the inner wall 20c) corresponding with an insert IN on base 23b, the portion of the screw T that comes out of the insert IN on base 23g can be used to secure base 23g to inner wall 20c, as shown in FIG. 3. The portion of the screw T that comes out of the insert IN in base 23g can be further secured via the nut N and O-ring OR, as also shown in FIG. 3. A similar approach may be used with bases 23d and 23e, which are both located on the inner wall 20c and are opposite to each other. Lastly, if screw T is inserted (from outside of the housing 20) through a hole HO (on the second outer wall 20b) corresponding with an insert IN on base 23h, the portion of the screw T that comes out of the insert IN in base 23h can be further secured via the nut N and O-ring OR, as shown in FIG. 3. A similar approach may be used with base 23f, which is also located on the second outer wall 20b.

Moreover, each base 23a-23h of each compartment has an opening H1-H8 at its center (each opening corresponding or defined by the ball bearings 24a-h) configured to receive an axle or portion of the shaft. Particularly, each of the first base and the second base of the first compartment include an opening H1, H2 configured to receive a first portion of a shaft 12a; each of the third base and the fourth base of the first compartment include an opening H3, H4 configured to receive an axle 26; each of the first base and the second base of the second compartment include an opening H5, H6 configured to receive the axle 26; and each of the third base and the fourth base of the second compartment include an opening H7, H8 configured to receive a second portion of the shaft 12b.

Similarly, each wall in the housing 20 comprises one or more openings O (corresponding with the location of some of the bases 23a-23h) that are also configured to receive an axle or portion of the shaft. Particularly, a first opening O is located in the first outer wall 20a and its location corresponds with the location of the opening H1 on the first base 23a of the first compartment 21a. A second opening O is located on the inner wall 20c and its location corresponds with the location of the opening H4 on the fourth base 23d of the first compartment 21a. A third opening O is also located in the inner wall 20c but its location corresponds with the location of the opening H5 on the first base 23e on the second compartment 21b. Lastly, a fourth opening O is located in the second outer wall 20b and its location corresponds with the location of the opening H8 on the fourth base 20h of the second compartment 21b, as shown in FIG. 4.

As shown in FIG. 3, the system 1 further comprises an axle 26 having a first end perpendicularly coupled to the second sprocket 25b; and a second end coupled to the third sprocket 25c, thereby tying together both sprockets and allowing them to interact with each other. As such, when sprocket 25b rotates, it causes the axle 26 to rotate, which in turn, causes sprocket 25c to rotate; and vice versa. It should be noted that the axle 26 has access to both sprockets 25b, 25c because it is inserted through openings H4 and H5 on bases 23d, 23e respectively, which correspond with the second and third openings O on the inner wall 20c. The third and fourth openings O on the inner wall 20c are located behind bases 23d and 23e, respectively.

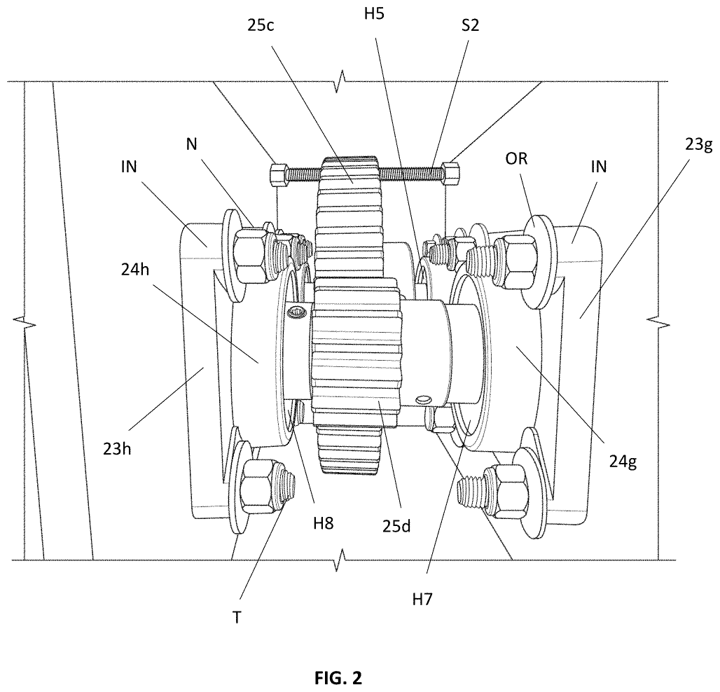

As shown in FIG. 1, a first end of the first portion of the drive shaft 12a, which is inserted through the opening O on the first outer wall 20a, is perpendicularly coupled to the first sprocket 25a. Rotation of the first portion of the drive shaft 12a causes the first sprocket 25a to rotate, which in turn causes the second sprocket 25b to spin. As noted above, rotation of the second sprocket 25b causes the axle 26 to rotate, which in turn, causes the third sprocket 25c to spin. Rotation of the third sprocket 25c, in turn, causes the fourth sprocket 25d to rotate. A first end of the second portion of the drive shaft 12b, which is inserted through the opening O on the second outer wall 20b, is perpendicularly coupled to the fourth sprocket 25d, as shown in FIGS. 2-3. A second end of the second portion of the drive shaft 12b is, in turn, coupled or connected to the rear differential 13a, which interacts with rear axle shafts 14a, 14b, causing movement of the vehicle's wheels. Alternatively, a second end of the first portion of the drive shaft 12a may be coupled to the transfer case 18 which, as noted above, transfers power from the transmission 11 to the front and rear axle shafts 14a, 14b, and 16a, 16b.

The system 1 is preferably used in front-engine rear-wheel drive vehicles but may also be used in front-wheel drive vehicles, four wheel and all-wheel drive vehicles. The system 1 may also be used in motored vehicles other than cars, such as motorcycles, is boats and jet skis.

Because there can be the present invention and that other embodiments without departing from the spirit and scope of the invention, the present invention will be appreciated that not limited to the specific embodiment example, defined in the claims.

What is claimed is:

1. A system for increasing the velocity of a motorized vehicle, comprising:
a housing, a plurality of bases, a plurality of sprockets, a plurality of ball bearings, an axle, and a drive shaft;
wherein the housing includes a bottom, a first outer wall, a second outer wall, and an inner wall, and wherein the first outer wall, the second outer wall, and the inner wall are all perpendicularly connected to the bottom of the housing;
wherein the inner wall divides the housing into two sections or compartments;
wherein the first compartment comprises a first base configured to support a first ball bearing, a second base located opposite to the first base and configured to support a second ball bearing, and a first sprocket located between the first and second ball bearings, wherein the first sprocket is connected to at least one of the first or second ball bearings;
wherein the first compartment further comprises a third base configured to support a third ball bearing, a fourth base located opposite to the third base and configured to support a fourth ball bearing, and a second sprocket located between the third and fourth ball bearings, wherein the second sprocket is connected to at least one of the third or fourth ball bearings;
wherein both the first sprocket and the second sprocket comprise teeth that are in contact with each other and are configured to interact with each other;
wherein the first base and the third base of the first compartment are located on the first outer wall and secured thereto via one or more screws, and wherein the second base and the fourth base of the first compartment are located on the inner wall and secured thereto via one or more screws;
wherein the second compartment comprises a first base configured to support a first ball bearing, a second base located opposite to the firsts base and configured to support a second ball bearing, and a third sprocket located between the first and second ball bearings, wherein the third sprocket is connected to at least one of the first or second ball bearings;
wherein the second compartment further comprises a third base configured to support a third ball bearing, a fourth base located opposite to the third base and configured to support a fourth ball bearing, and a fourth sprocket located between the third and fourth ball bearings, wherein the fourth sprocket is connected to at least one of the third or fourth ball bearings;
wherein both the third sprocket and the fourth sprocket comprise teeth that are in contact with each other and are configured to interact with each other;
wherein the first base and the third base of the second compartment are located on the inner wall and secured thereto via one or more screws, and wherein the second base and the fourth base of the second compartment are located on the second outer wall and secured thereto via one or more screws;
wherein each base comprises one or more inserts configured to receive the corresponding one or more screws for securing each base to the corresponding inner wall or outer wall;
wherein each of the inner wall and the outer wall includes one or more holes corresponding with the inserts of each base;
wherein each of the first base and the second base of the first compartment include an opening configured to receive a first portion of the drive shaft;
wherein each of the third base and the fourth base of the first compartment include an opening configured to receive an axle;
wherein each of the first base and the second base of the second compartment include an opening configured to receive the axle;
wherein each of the third base and the fourth base of the second compartment include an opening configured to receive a second portion of the drive shaft;
wherein the first outer wall is configured to receive the first portion of the drive shaft;
wherein the second outer wall is configured to receive the second portion of the drive shaft;
wherein the inner wall is configured to receive the axle;
wherein the axle comprises a first end perpendicularly coupled to the second sprocket and a second end coupled to the third sprocket;
wherein a first portion of the drive shaft is perpendicularly coupled to the first sprocket, and
wherein a second portion of the drive shaft is perpendicularly coupled to the fourth sprocket.

2. The system for increasing the velocity of a motorized vehicle of claim 1, wherein the two sections or compartments have the same size.

3. The system for increasing the velocity of a motorized vehicle of claim 1, wherein both compartments include one or more screws adapted to adjust or provide support to the outer and inner walls.

4. The system for increasing the velocity of a motorized vehicle of claim 1, wherein the first sprocket is larger in size than the second sprocket.

5. The system for increasing the velocity of a motorized vehicle of claim 1:
wherein the first outer wall includes a first opening having a location that corresponds with the location of the opening on the first base of the first compartment, the first opening of the first outer wall being configured to receive the drive shaft,
wherein the inner wall includes a second opening having a location that corresponds with the location of the opening on the fourth base of the first compartment, the second opening of the inner wall being configured to receive the axle,
wherein the inner wall includes a third opening having a location that corresponds with the location of the opening on the first base of the second compartment, the third opening of the inner wall being configured to receive the axle, and
wherein the second outer wall includes a fourth opening having a location that corresponds with the location of the opening on the fourth base of the second compartment, the fourth opening of the second outer wall being configured to receive the drive shaft.

6. The system for increasing the velocity of a motorized vehicle of claim 1, wherein the housing is adapted to be placed between a transmission and a rear differential of a vehicle.

7. The system for increasing the velocity of a motorized vehicle of claim 6, wherein the second portion of the drive shaft is adapted to couple to the rear differential of the vehicle.

8. The system for increasing the velocity of a motorized vehicle of claim 1, wherein the first portion of the drive shaft is adapted to couple to a transfer case of a vehicle.
